(19) United States
(12) Patent Application Publication
(10) Pub. No.: US 2017/0254365 A1
(43) Pub. Date: Sep. 7, 2017

(54) Universal Joint Structure

(71) Applicant: Chao-Ming Chen, Taichung City (TW)

(72) Inventor: Chao-Ming Chen, Taichung City (TW)

(21) Appl. No.: 15/058,222

(22) Filed: Mar. 2, 2016

(51) Int. Cl. F16D 3/221

(52) U.S. Cl. CPC F16D 3/221

(57) ABSTRACT

A connecting rod device for tools contains: a base, a connector, and a limiting element. The base includes a fitting portion, an accommodation portion and at least two locking grooves. The connector includes a spherical knob formed on a first end thereof and accommodated in the accommodation portion of the base, and the connector also includes a drive portion arranged on a second end thereof, wherein the spherical knob has at least two receiving grooves defined therein and corresponding to the at least two locking grooves of the base respectively so as to accommodate at least two balls respectively, and the at least two balls rotatably retain with and drives the at least two locking grooves of the base individually. The limiting element is housed in the accommodation portion of the base so as to limit the spherical knob of the connector in the accommodation portion of the base.

### FIELD OF THE INVENTION

The present invention relates to a universal joint structure which enhances locking force and service life of a base and a connector of the universal joint structure.

### BACKGROUND OF THE INVENTION

Referring to FIG. 1, a conventional universal joint contains a base 10, a connector 11, a retainer 12, and a fitting ring 13. The base 10 includes a fitting portion 101 arranged on a lower end thereof so as to fit with a driving tool, an accommodation portion 102 defined on an upper end thereof so as to accommodate a spring 103, and two through holes 104 communicating with the accommodation portion 102. The connector 11 includes a spherical knob 111 formed on a first end thereof and housed in the accommodation portion 102 of the base 10, a driving portion 112 arranged on a second end thereof so as to fit with a socket, and a fixing groove 113 defined in the spherical knob 111 and corresponding to the two through holes 103 of the base 10, hence the retainer 12 inserts into the two through holes 104 of the base 10 and the fixing groove 113 of the connector 11 so that the spherical knob 111 of the connector 11 limits in the accommodation portion 102 of the base 10, the spherical knob 111 of the connector 11 rotates along the retainer 12, thus rotating the connector 11 in a first direction. Furthermore, the spherical knob 111 rotates in the fixing groove 113 of the connector 11 along the retainer 12 in a second direction so that the spherical knob 111 of the connector 11 rotates in the second direction, and the connector 11 rotates universally. The fitting ring 13 is fitted with the base 10 so as to fix the retainer 12. In operation, the spherical knob 111 of the connector 11 is accommodated in the accommodation portion 102 of the base 10, but when the base 10 retains and drives the connector 11 to rotate by using the retainer 12, the base 10 forces the retainer 12 powerfully, thus causing damage of the retainer 12.

Referring to FIGS. 2 to 4, a tool joint 20 is disclosed in TW Publication No. M357344 and contains a working segment 21, a support extension 22, and a limitation structure. The working segment 21 includes a first end connecting with a driving tool, an accommodation groove 211 defined on a second end thereof, and a plurality of arcuate ribs 212 arranged on a peripheral wall of the accommodation groove 211. The support extension 22 includes a polygonal knob 221 formed on a first end thereof and housed in the accommodation groove 211 of the working segment 21, wherein the polygonal knob 221 has a plurality of contact faces contacting with the plurality of arcuate ribs 212 respectively. The support extension 22 also includes a driving portion 222 arranged on a second end thereof so as to fit with other tools. The limiting structure is a C retainer 23 accommodated in the accommodation groove 211 of the working segment 21 so as to limit the polygonal knob 221 of the support extension 22. In operation, the plurality of arcuate ribs 212 of the working segment 21 contact with the plurality of contact faces of the polygonal knob 221 of the support extension 22 so as to drive the support extension 22 to rotate along the polygonal knob 221. However, such a tool joint 20 has defects as follows:

1. The working segment 21 retains the polygonal knob 221 of the support extension 22 by way of the plurality of arcuate ribs 212 so as to drive the support extension 22 to revolve. A raised thickness T of each arcuate rib 212 of the working segment 21 is limited by the plurality of contact faces of the polygonal knob 221 of the support extension 22, so a locking torque is reduced. In addition, the polygonal knob 221 of the support extension 22 scratches the plurality of arcuate ribs 212 of the working segment 21 easily to decrease locking force.

2. When the working segment 21 and the support extension 22 rotate, the plurality of arcuate ribs 212 of the working segment 21 contact with and scratch the plurality of contact faces of the polygonal knob 221, so the working segment 21 and the support extension 22 cannot rotate smoothly.

The present invention has arisen to mitigate and/or obviate the afore-described disadvantages.

### SUMMARY OF THE INVENTION

The primary objective of the present invention is to provide a universal joint structure which avoids each ball of a connector scratching each locking groove of a base so as to enhance locking force and service life of the base and the connector.

Another objective of the present invention is to provide a universal joint structure in which said each ball of the connector rotatably retains with said each locking groove of the base so that the connector rotates in the base smoothly and universally.

To obtain above objects, a universal joint structure provided by the present invention contains: a base, a connector, and a limiting element.

The base includes a fitting portion formed on a first end thereof, an accommodation portion arranged on a second end thereof, and at least two locking grooves defined on an inner surface of the accommodation portion.

The connector includes a spherical knob formed on a first end thereof and accommodated in the accommodation portion of the base, and the connector also includes a drive portion arranged on a second end thereof, wherein the spherical knob has at least two receiving grooves defined therein and corresponding to the at least two locking grooves of the base respectively so as to accommodate at least two balls respectively, the at least two balls rotatably retain with the at least two locking grooves of the base individually.

The limiting element is housed in the accommodation portion of the base so as to limit the spherical knob of the connector in the accommodation portion of the base.

### BRIEF DESCRIPTION OF THE DRAWINGS

FIG. 1 is a cross sectional view showing the operation of a conventional universal joint.

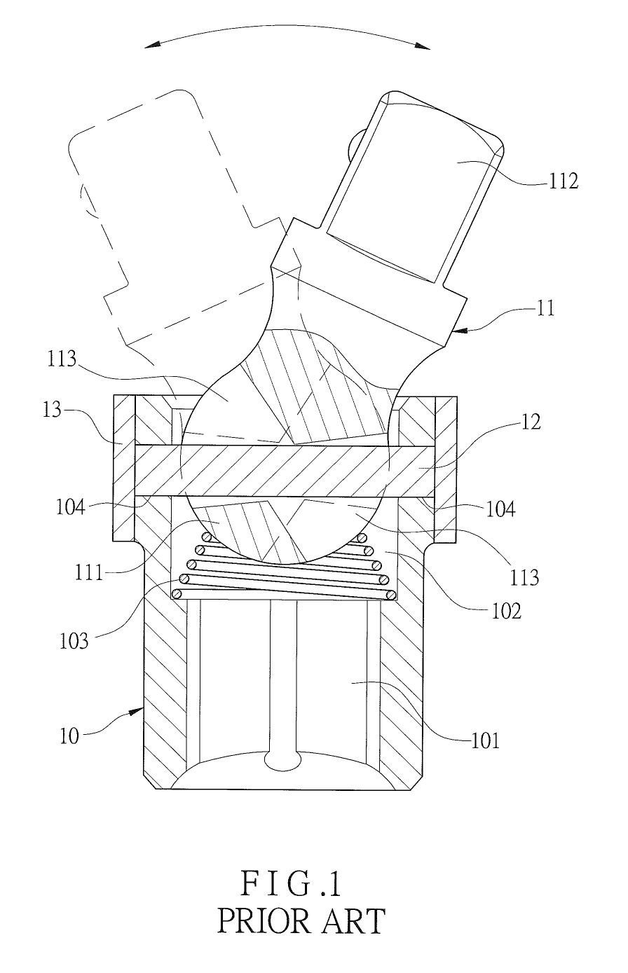

FIG. 2 is a perspective view showing the exploded components of a tool joint disclosed in TW Publication No. M357344.

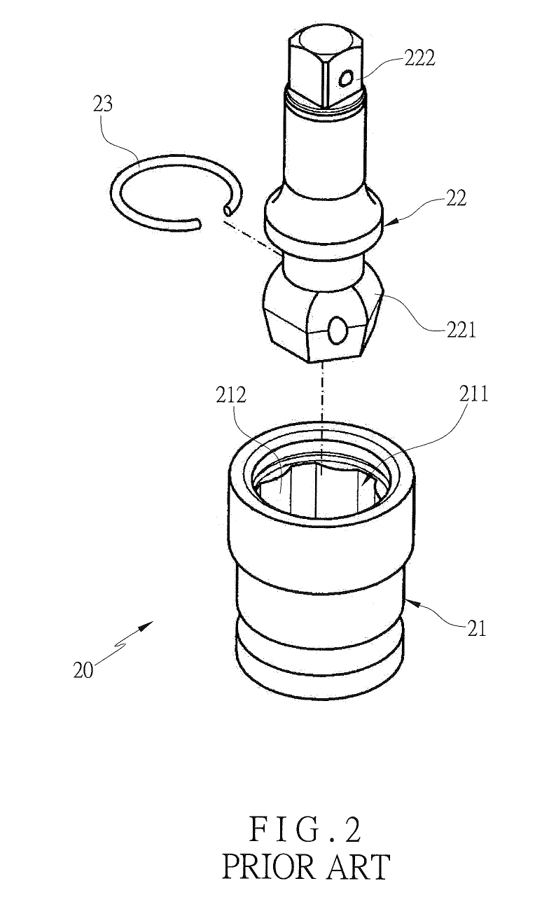

FIG. 3 is a cross sectional view showing the operation of the tool joint disclosed in TW Publication No. M357344.

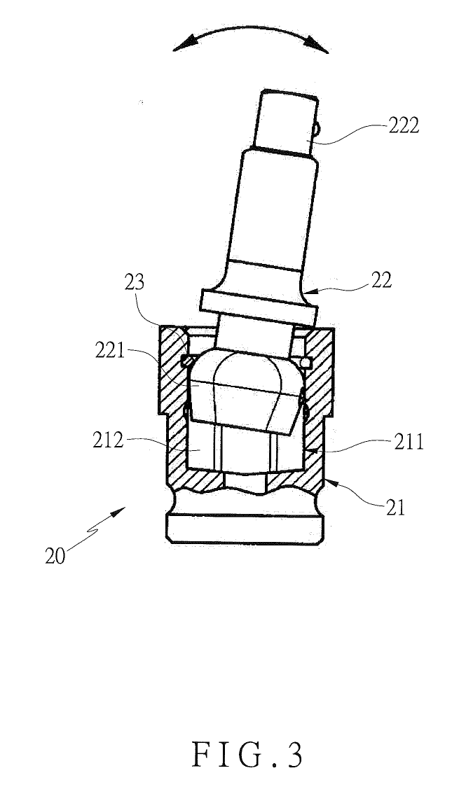

FIG. 4 is a cross sectional view showing the assembly of a part of the tool joint disclosed in TW Publication No. M357344.

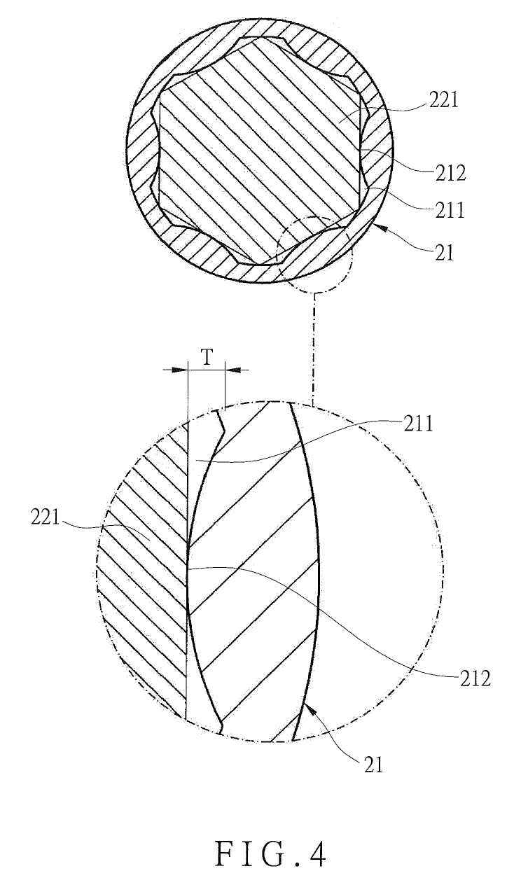

FIG. 5 is a perspective view showing the exploded components of a universal joint structure according to a first embodiment of the present invention.

FIG. 6 is a perspective view showing the assembly of the universal joint structure according to the first embodiment of the present invention.

FIG. 7 is a cross sectional view showing the assembly of the universal joint structure according to the first embodiment of the present invention.

FIG. 8 is a cross sectional view taken the lines A-A of FIG. 7.

FIG. 9 is a cross sectional view showing the operation of the universal joint structure according to the first embodiment of the present invention.

FIG. 10 is another cross sectional view showing the operation of the universal joint structure according to the first embodiment of the present invention.

FIG. 11 is also another cross sectional view showing the operation of the universal joint structure according to the first embodiment of the present invention.

FIG. 12 is a perspective view showing the exploded components of a universal joint structure according to a second embodiment of the present invention.

FIG. 13 is a perspective view showing the assembly of the universal joint structure according to the second embodiment of the present invention.

FIG. 14 is a cross sectional view showing the assembly of the universal joint structure according to the second embodiment of the present invention.

FIG. 15 is a cross sectional view taken the lines B-B of FIG. 14.

FIG. 16 is a cross sectional view showing the operation of the universal joint structure according to the second embodiment of the present invention.

FIG. 17 is another cross sectional view showing the operation of the universal joint structure according to the second embodiment of the present invention.

### DETAILED DESCRIPTION OF THE PREFERRED EMBODIMENTS

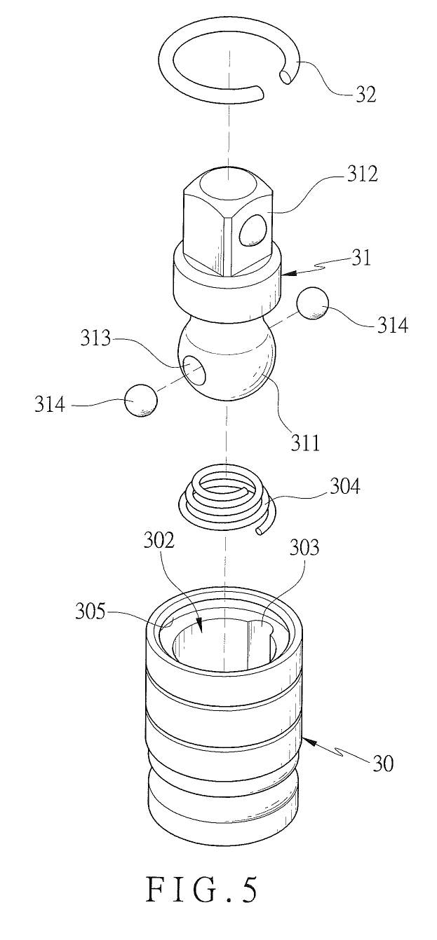

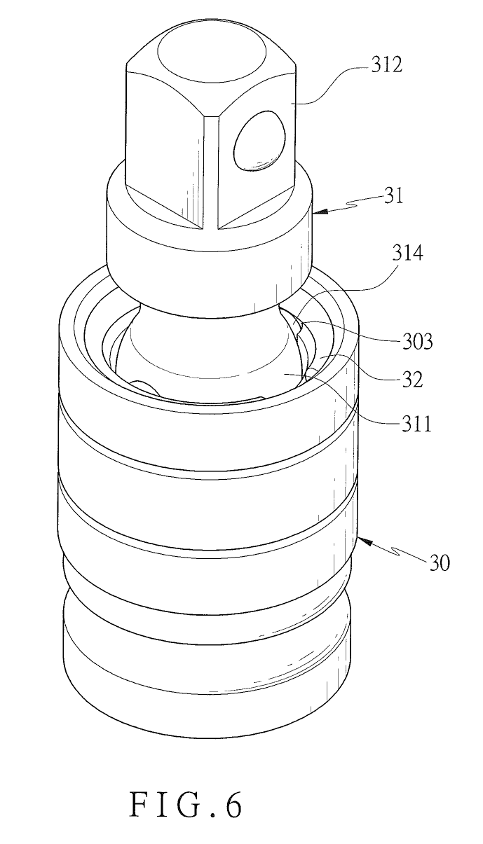

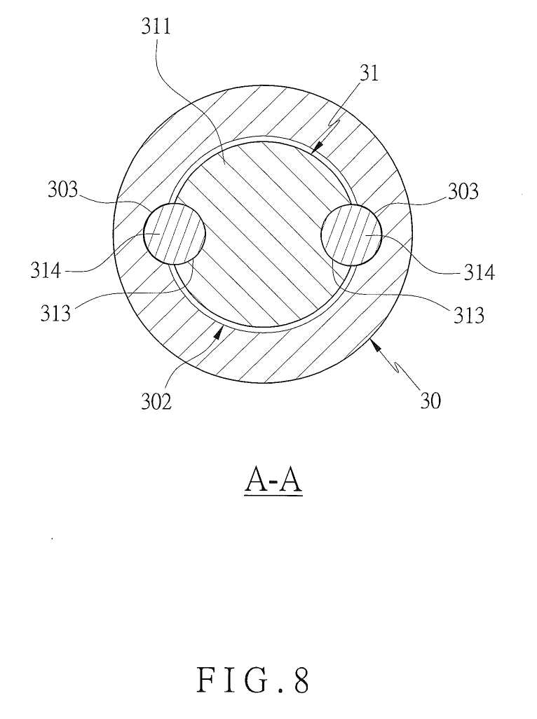

With reference to FIGS. 5 to 8, a universal joint structure according to a first embodiment of the present invention comprises: a base 30, a connector 31, and a limiting element 32. The base 30 includes a fitting portion 301 formed on a first end thereof so as to fit with a driving tool (such as a pneumatic tool or a wrench). In this embodiment, the fitting portion 301 of the base 30 is a quadrangular hole. The base 30 also includes an accommodation portion 302 arranged on a second end thereof and includes at least two locking grooves 303 defined on an inner surface of the accommodation portion 302. In this embodiment, the accommodation portion 302 of the base 30 has two concavely spherical locking grooves 303 oppositely arranged therein and accommodates a resilient element 304 (such as a spring). The connector 31 includes a spherical knob 311 formed on a first end thereof and accommodated in the accommodation portion 302 of the base 30, and the resilient element 304 in the accommodation portion 302 of the base 30 pushes the spherical knob 311 of the connector 31 outwardly, the connector 31 also includes a drive portion 312 arranged on a second end thereof. In this embodiment, the drive portion 312 of the connector 31 is a quadrangular column so as to couple with a socket. The spherical knob 311 of the connector 31 has two opposite receiving grooves 313 defined therein and corresponding to the two locking grooves 303 of the base 30 so as to accommodate two balls 314 which rotatably retain with the two locking grooves 303 of the base 30 respectively, such that the two balls 314 rotate in the two locking grooves 303 in response to a rotation of the connector 31. In this embodiment, each receiving groove 313 of the spherical knob 311 of the connector 31 is concavely spherical so as to correspond to and contact with a first spherical face of said each ball 314, wherein a second spherical face of said each ball 314 extends into and retains with each locking groove 303 of the base 30. The accommodation portion 302 of the base 30 houses the limiting element 32 so as to limit the spherical knob 311 of the connector 31 in the accommodation portion 302 of the base 30. The inner surface of the accommodation portion 302 of the base 30 has a peripheral trench 305 corresponding to the spherical knob 311 of the connector 31 so as to accommodate the limiting element 32 which is a C ring, hence when the resilient element 304 pushes the spherical knob 311 of the connector 31 outwardly, the limiting element 32 stops said each ball 314 of the spherical knob 311 so that the spherical knob 311 of the connector 31 is limited in the accommodation portion 302 of the base 30.

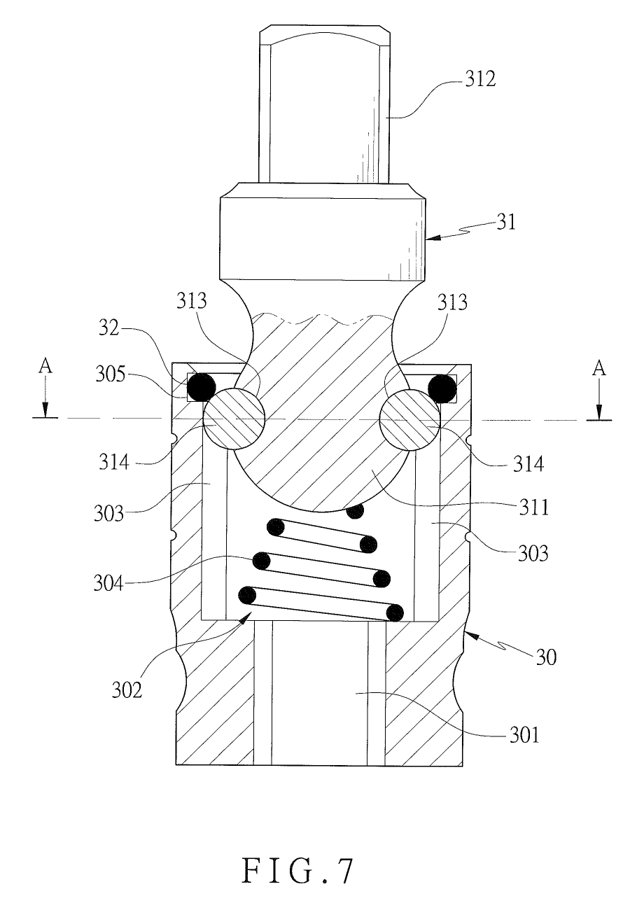

Referring to FIG. 7, said each ball 314 of the spherical knob 311 of the connector 31 extends into and retains with said each locking groove 303 of the base 30, such that when said each locking groove 303 of the base 30 forces said each ball 314, said each ball 314 does not scratch said each locking groove 303 of the base 30, thus enhancing locking force and service life of the base 30 and the connector 31.

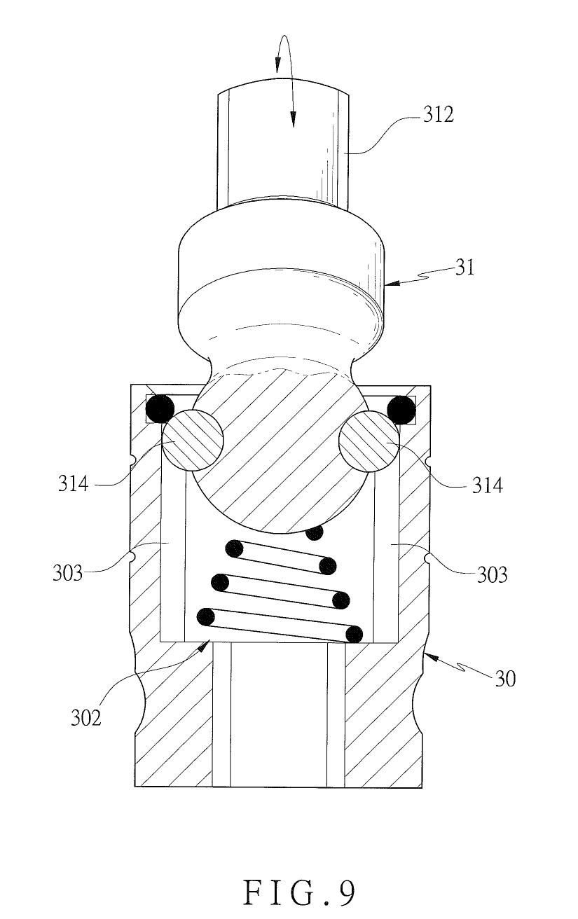

As shown in FIG. 9, the spherical knob 311 of the connector 31 rotates in the accommodation portion 302 of the base 30 easily, hence when the spherical knob 311 of the connector 31 rotates in a first direction along the two balls 314, the two balls 314 rotatably contact with the two locking grooves 303 so as to reduce friction between said each ball 314 and said each locking groove 303, and the connector 31 rotates smoothly in the first direction.

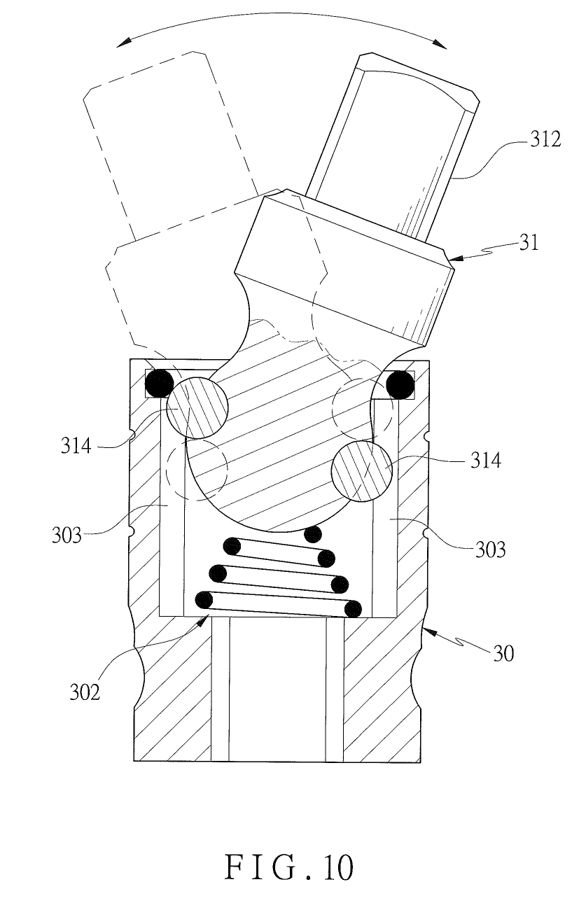

As illustrated in FIG. 10, when the spherical knob 311 of the connector 31 rotates along the two locking grooves 303 in a second direction by way of the two balls 314, the two balls 314 rotatably contact with the two locking grooves 303 of the base 30 so as to reduce friction between the spherical knob 311 and the two locking grooves 303, hence the connector 31 rotates in the second direction smoothly.

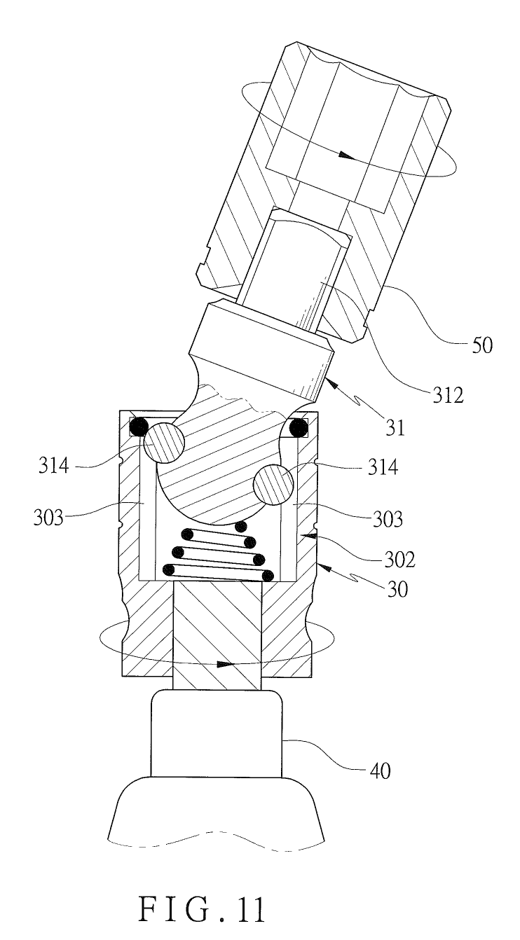

With reference to FIG. 11, in operation, the fitting portion 301 of the base 30 fits with the driving tool 40, and the drive portion 312 of the connector 31 fits with the socket 50. Since the two balls 314 rotate in the two locking grooves 303 of the base 30 respectively, the connector 31 rotates easily, and when the driving tool 40 drives the base 30 to rotate, the two locking grooves 303 of the base 30 retain with the two balls 314 so as to drive the connector 31 to rotate, and the drive portion 312 of the connector 31 drives the socket 50 to revolve, thus fixing or removing a workpiece in a narrow operation space.

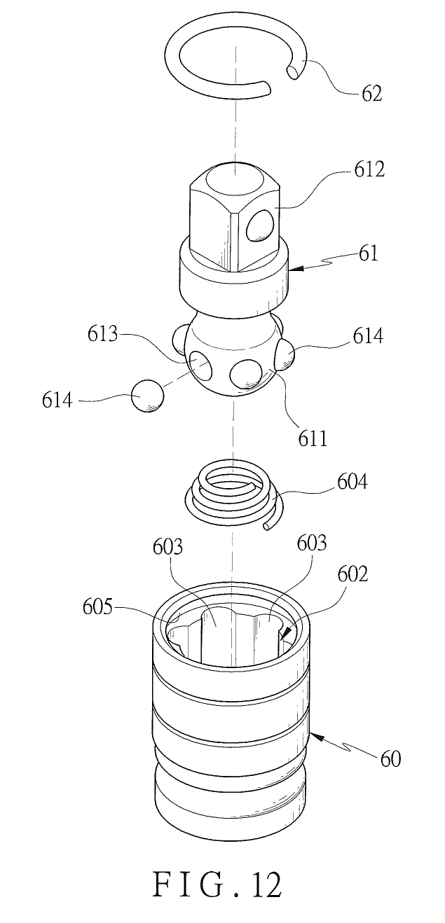

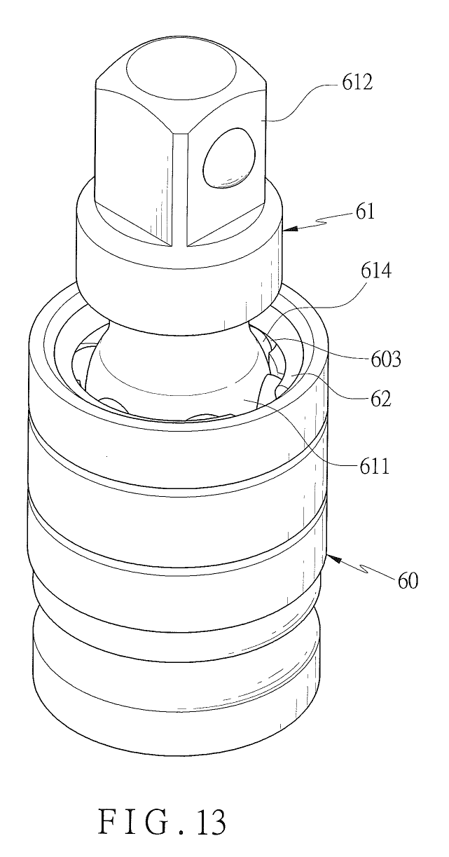

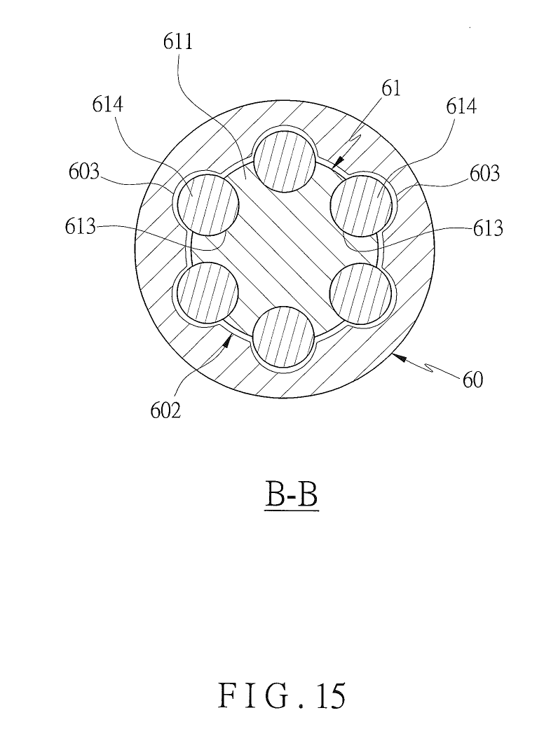

With reference to FIGS. 12 to 15, a universal joint structure according to a second embodiment of the present invention comprises: a base 60, a connector 61, and a limiting element 62. The base 60 includes a fitting portion 601 formed on a first end thereof so as to fit with a driving tool (such as a pneumatic tool or a wrench). In this embodiment, the fitting portion 601 of the base 60 is a quadrangular hole. The base 60 also includes an accommodation portion 602 arranged on a second end thereof and includes six locking grooves 603 equidistantly defined on an inner surface of the accommodation portion 602. In this embodiment, the accommodation portion 602 of the base 60 has the six locking grooves 603 which are concavely spherical and accommodate a resilient element 604 (such as a spring). The connector 61 includes a spherical knob 611 formed on a first end thereof and accommodated in the accommodation portion 602 of the base 60, and the resilient element 604 in the accommodation portion 602 of the base 60 pushes the spherical knob 611 of the connector 61 outwardly, the connector 61 also includes a drive portion 612 arranged on a second end thereof. In this embodiment, the drive portion 612 of the connector 61 is a quadrangular column so as to couple with a socket. The spherical knob 611 of the connector 61 has six receiving grooves 613 equidistantly defined therein and corresponding to the six locking grooves 603 of the base 60 so as to accommodate six balls 614 which rotatably retain with the six locking grooves 603 of the base 60 respectively, wherein a diameter of each locking groove 603 of the base 60 is more than each ball 614 so that said each ball 614 rotates in said locking groove 603 in response to a rotation of the connector 61. In this embodiment, each receiving groove 613 of the spherical knob 611 of the connector 61 is concavely spherical so as to correspond to and contact with a first spherical face of said each ball 614, wherein a second spherical face of said each ball 614 extends into and retains with each locking groove 603 of the base 60. The accommodation portion 602 of the base 60 houses the limiting element 62 so as to limit the spherical knob 611 of the connector 61 in the accommodation portion 602 of the base 60. The inner surface of the accommodation portion 602 of the base 60 has a peripheral trench 605 corresponding to the spherical knob 611 of the connector 61 so as to accommodate the limiting element 62 which is a C ring, hence when the resilient element 604 pushes the spherical knob 611 of the connector 61 outwardly, the limiting element 62 stops said each ball 614 of the spherical knob 611 so that the spherical knob 611 of the connector 61 is limited in the accommodation portion 602 of the base 60.

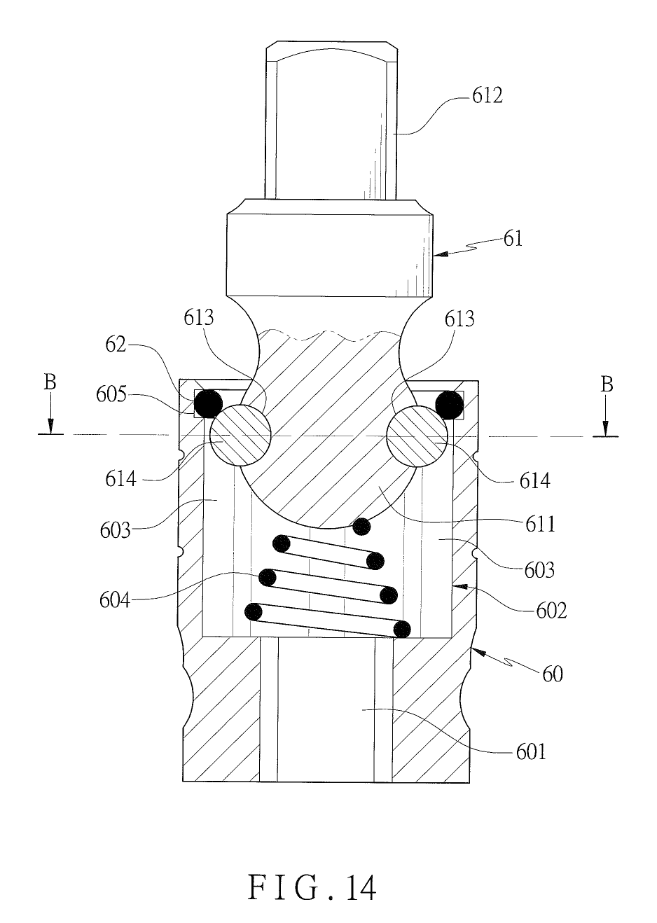

Referring to FIG. 14, said each ball 614 of the spherical knob 611 of the connector 61 extends into and retains with said each locking groove 603 of the base 60, such that when said each locking groove 603 of the base 60 forces said each ball 614, said each ball 614 does not scratch said each locking groove 603 of the base 60, thus enhancing locking force and service life of the base 60 and the connector 61.

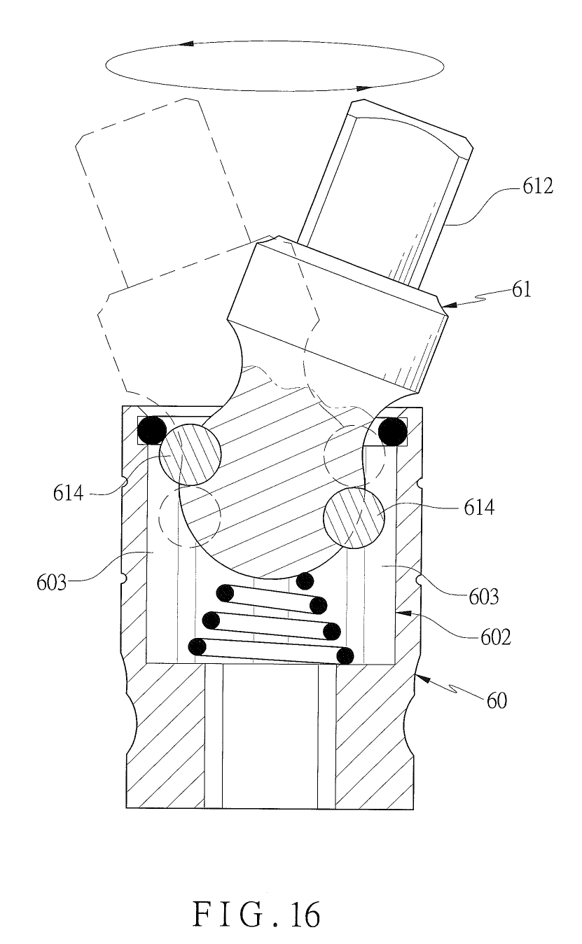

As shown in FIG. 16, the base 60 includes the six locking grooves 603 equidistantly defined on the inner surface of the accommodation portion 602, and the spherical knob 611 has the six receiving grooves 613 for accommodating the six balls 614 respectively, hence the connector 61 rotates in the accommodation portion 602 of the base 60 universally, the six balls 614 rotatably contact with the six locking grooves 603 so as to reduce a friction between said each ball 614 and said each locking groove 603, and the connector 61 rotates smoothly.

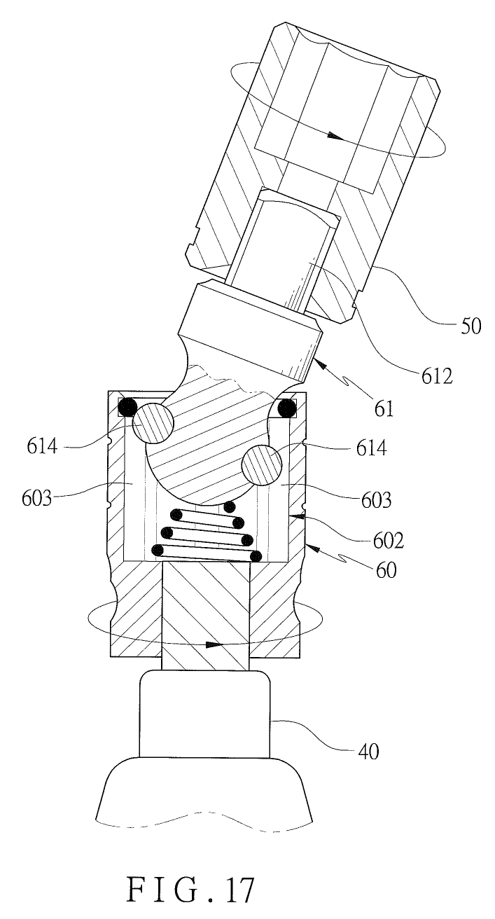

With reference to FIG. 17, in operation, the fitting portion 601 of the base 60 fits with the driving tool 40, and the drive portion 612 of the connector 61 fits with the socket 50. Since the six balls 614 rotate in the six locking grooves 603 of the base 60, the connector 61 rotates easily, and when the driving tool 40 drives the base 60 to rotate, the six locking grooves 603 of the base 630 retain the six balls 614 so as to drive the connector 61 to rotate, and the drive portion 612 of the connector 61 drives the socket 50 to revolve, thus fixing or removing a workpiece in a narrow operation space.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A universal joint structure comprising:
a base including a fitting portion formed on a first end thereof, an accommodation portion arranged on a second end thereof, and at least two locking grooves defined on an inner surface of the accommodation portion;
a connector including a spherical knob formed on a first end thereof and accommodated in the accommodation portion of the base, and the connector also including a drive portion arranged on a second end thereof, wherein the spherical knob has at least two receiving grooves defined therein and corresponding to the at least two locking grooves of the base respectively so as to accommodate at least two balls respectively, the at least two balls rotatably retain with the at least two locking grooves of the base individually;
a limiting element housed in the accommodation portion of the base so as to limit the spherical knob of the connector in the accommodation portion of the base.

2. The universal joint structure as claimed in claim 1, wherein the fitting portion of the base is a quadrangular hole.

3. The universal joint structure as claimed in claim 1, wherein each of the at least two locking grooves of the base is concavely spherical so as to rotatably retain with and drive each of the at least two balls in the spherical knob.

4. The universal joint structure as claimed in claim 1, wherein each of the at least two receiving grooves of the spherical knob is concavely spherical so as to correspond to and contact with a first spherical face of said each ball.

5. The universal joint structure as claimed in claim 1, wherein the accommodation portion of the base accommodates a resilient element for pushing the spherical knob of the connector outwardly.

6. The universal joint structure as claimed in claim 1, wherein the accommodation portion of the base has two locking grooves oppositely arranged therein, and the spherical knob of the connector accommodates two balls which correspond to the two locking grooves of the base.

7. The universal joint structure as claimed in claim 1, wherein the base includes six locking grooves equidistantly defined on an inner surface of the accommodation portion, and the spherical knob of the connector accommodates six balls which correspond to the six locking grooves of the base.

8. The universal joint structure as claimed in claim 7, wherein a diameter of each locking groove of the base is more than each ball so that said each ball rotates in said locking groove.

9. The universal joint structure as claimed in claim 1, wherein the inner surface of the accommodation portion of the base has a peripheral trench corresponding to the spherical knob of the connector so as to accommodate the limiting element, and the limiting element stops said each ball of the spherical knob so that the spherical knob of the connector is limited in the accommodation portion of the base.

10. The universal joint structure as claimed in claim 9, wherein the limiting element is a C ring.
